(19) United States
(12) Patent Application Publication
(10) Pub. No.: US 2015/0096838 A1
(43) Pub. Date: Apr. 9, 2015

(54) SELF-BLOCKING DESCENDER-BELAY DEVICE

(71) Applicant: ETABLISSEMENTS SIMOND, Les Houches (FR)

(72) Inventors: Patrick Lefebvre, Chamonix Mont Blanc (FR); Mathieu Mansuy, La Bresse (FR); Romain Molliex, Scionzier (FR)

(21) Appl. No.: 14/506,747

(22) Filed: Oct. 6, 2014

(30) Foreign Application Priority Data
Oct. 7, 2013 (FR) 13 59723

(51) Int. Cl. A62B 1/14; A63B 29/02

(52) U.S. Cl. CPC A62B 1/14; A63B 29/02
USPC 182/191

(57) ABSTRACT

The self-blocking descender-belay device (1) according to the invention comprises:
a first lateral guide flange (6) for the rope, comprising a braking nose (4e),
a second lateral guide flange (7) for the rope, which is separated from the first flange (6) by a transverse gap (8) for passage of the rope, and can be displaced between a spaced position for putting into place and removal of a rope, and a closed position in which the rope is trapped in the transverse gap (8) for passage of the rope,
a cam (4d) which is engaged between the first and second flanges (6, 7) and is mobile towards and away from the braking nose (4e), and is thrust towards the braking nose (4e) by a cam return spring,
the transverse gap (8) for passage of the rope extending between a rope input in the vicinity of the braking nose (4e), and a rope output opposite,
the rope output having a large opening such as to permit free orientation of the rope output end between a blocking orientation in which the rope surrounds the cam (4d), and a release orientation in which the rope passes through the transverse gap (8) for passage of the rope directly, and without thrusting the cam (4d) towards the braking nose (4e).

### TECHNICAL FIELD OF THE INVENTION

The present invention relates to a self-blocking descender-belay device which is designed to be used to control the paying-out of a rope, for example for the descent of a person down a rope, or for belaying of a person.

Various descender-belay device structures are already known, for example such as that which is described in document EP 0 688 581 B1.

A known descender-belay device of this type comprises:
a first lateral guide flange for the rope, comprising a braking nose,
a second lateral guide flange for the rope, which is separated from the first flange by a transverse gap for passage of the rope, and can be displaced between a spaced position for putting into place and removal of the rope, and a closed position in which the rope is trapped in the transverse gap for passage of the rope,
a cam which is engaged between the first and second flanges and is mobile towards and away from the braking nose,
a cam manoeuvring unit, which can be activated by a user in order to displace the cam away from the braking nose,
a cam return spring, in order to thrust the cam in its movement between the first and second flanges,
the transverse gap for passage of the rope extending between a rope input in the vicinity of the braking nose, and a rope output in the vicinity of the cam,
the rope output being formed such as to permit orientation of the output end of the rope according to a blocking orientation in which the rope passes through the transverse gap for passage of the rope, whilst enveloping the cam, and thrusting it towards the braking nose,
at least one of the first and second flanges extending longitudinally from a connection end, where there are situated the braking nose, the cam and the transverse gap for passage of the rope, to a coupling end where coupling means are situated.

In this known descender-belay device, the cam return spring thrusts the cam away from the braking nose, in order to assist the sliding of the rope in the absence of tension on the rope.

When the cam manoeuvring unit is released during a movement of descent down the rope, the tension on the rope thrusts the cam towards the braking nose, such that the rope is pressed by the cam against the braking nose. This results in braking of the movement of descent.

However, it is found in this device that the automatic triggering of the braking requires tension of the rope which is sufficiently sudden and strong to drive the cam against its return spring. In the presence of reduced tension, or relatively slow application of the tension of the rope, the blocking of the rope does not take place, and the self-blocking function is not fulfilled.

On the other hand, the deliberate reduction of braking by the user is not regular. Firstly, by using the cam manoeuvring unit in order to allow the rope to pay out with braking, the paying-out of the rope is relatively jerky. Secondly, in order to supply a climber with free rope, it is necessary to inhibit the braking. This leads the user to act directly with his hand on the cam, in order to space it from the braking nose, with the risk of forgetting to release the hand when blocking is necessary.

A device according to the preamble of claim 1 is also known from document JP 2011-200 640 A. In this document, the objective is essentially to ensure automatic blocking of the rope in the absence of thrusting on the cam by the user. For this purpose, the path for passage of the rope is permanently in the form of an arc of a circle, irrespective of the orientation of the output end of the rope. The cam is arranged halfway between the two longitudinal ends of the body of the device. The paying-out of the rope is permitted only if the user thrusts the cam in rotation. Thus, this device does not make it possible to control easily the braking of the rope in order to allow it to be paid out regularly with or without a load.

The object of the present invention is to eliminate the disadvantages of the known descender-belay devices, whilst making it possible to fulfill efficiently the two contradictory functions of a descender-belay device, i.e. great ease and efficiency in permitting the deliberate paying-out of a rope, and secure blocking of the rope as soon as tension occurs, and in the absence of intervention by the user, even in the presence of a slight tension and/or a slow speed of paying-out of the rope.

It will be appreciated that these two functions are contradictory, in that easy paying-out of the rope needs great ease of spacing of the cam from the braking nose, whereas secure blocking requires great ease of displacement of the cam towards the braking nose.

### SUMMARY OF THE INVENTION

In order to achieve these objectives and others, the invention proposes a self-blocking descender-belay device to control the paying-out of a rope, comprising:
a first lateral guide flange for the rope, which is integral with a braking nose,
a second lateral guide flange for the rope, which is separated from the first lateral guide flange for the rope by a path for passage of the rope, and can be displaced between a spaced position for putting into place and removal of the rope, and a closed position in which the rope is trapped in the transverse gap for passage of the rope,
a cam which is engaged between the first and second lateral guide flanges for the rope, and is mobile towards and away from the braking nose, from which it is separated by an intermediate section of path,
a cam manoeuvring unit, which can be activated by a user, in order to displace the cam away from the braking nose,
a cam return spring, in order to thrust the cam towards the braking nose, in its movement between the first and second flanges,
the path for passage of the rope extending on both sides of the intermediate section of path, between a path input in the vicinity of the braking nose, and a path output,
the path output comprising a blocking output portion which passes round the cam, and along which there can pass an output end of the rope, which thus thrusts the cam towards the braking nose,
at least one of the first and second flanges extending longitudinally from a connection end, where there are situated the braking nose, the cam and the path for passage of the rope, to a proximal end area where coupling means are situated;
   and in addition, according to the invention:
the path output extends laterally according to a large opening, between the first and second flanges, from the blocking output portion, to a release output portion which is in line with the path input and the intermediate section of path, in order to define a generally straight passage, along which the output end of the rope can pass directly, without thrusting the cam towards the braking nose.

As a result of the presence of the cam return spring, which thrusts the cam towards the braking nose, contrary to the arrangement indicated in the prior document EP 0 688 581 B1, in the absence of thrusting by the user the automatic blocking of the rope is ensured even in the presence of a slight tension or a slow speed of paying-out, since the spring gives rise to the start of the blocking, which then makes the descender-belay device pivot to a blocking position, in which the start of the blocking is immediately completed by the force exerted on the cam by the taut rope. The resilient thrust of the cam towards the braking nose thus reduces the blocking time very substantially, and prevents blocking faults.

Simultaneously, thanks to the wide path output which permits free orientation of the output end of the rope, contrary to the prior documents, the descender-belay device can be oriented deliberately by the user away from the blocking position, in order to provide it with a release orientation, in which the output end of the rope is in the extension of the rope input, and thus avoids thrusting the cam towards the braking nose, consequently ensuring efficient and adjustable release, even in the presence of the residual braking caused by the thrust of the cam return spring.

As a result, the range of non-triggering of the blocking of a descender-belay device of this type is reduced, and it exists only in the case when the user maintains the descender-belay device in the release orientation, whereas, as soon as the user releases the descender-belay device in the presence of tension of the rope, the rope automatically goes into the blocking orientation in which the rope envelops the cam, and ensures immediate blocking.

According to a first embodiment, in its movement towards and away from the braking nose, the cam can be guided by guide slides.

According to a preferred embodiment, the cam is mobile in rotation around a rotational cam shaft, which, in relation to the cam, is situated on the other side of the intermediate section of path, and is offset in the direction of the proximal end area.

A movement of rotation of this type is simple to carry out and to reproduce reliably, even in the presence of mud, dust, or foreign bodies which can oppose the movement of the cam. In addition, the cam is thus efficiently thrust by the rope in an appropriate manner in the two situations of blocking and release.

Preferably, the cam is supported by the second lateral guide flange for the rope.

In this case, the cam is advantageously associated with a first cam lug, which is displaced in an aperture in the form of an arc of a circle provided in the second lateral guide flange for the rope, such as to guide the cam, and to take over some of the traction forces withstood by the descender-belay device.

According to the invention, means are provided for locking the flanges in the closed position, such as to prevent any risk of untimely opening of the descender-belay device, which opening would be liable to release the rope.

According to an advantageous embodiment, this locking can be ensured by the cam itself, by associating the cam with a second cam lug which is displaced on a guide path provided in the first lateral guide flange, and by providing the guide path with two successive guide sections, i.e.:
a first section for guiding according to the movement of rotation of the cam on the second flange around the rotational cam shaft,
a second section for guiding according to a movement of rotation of the second flange relative to the first flange around a flange shaft,
the rotational cam shaft and the flange shaft being spaced apart from one another, and the second guide section being connected to the first guide section by an angle which is not zero.

Since the cam is thrust back by the cam return spring, the second cam lug is at the beginning of the first guide section, and opposes the rotation of the second flange, such that, by means of its second cam lug, the cam itself ensures a first locking of the second flange in the closed position.

Advantageously, a button can additionally be provided for unlocking of the second lateral guide flange relative to the first lateral guide flange.

Advantageously, the cam manoeuvring unit can comprise a lever which is articulated on one of the lateral guide flanges, and is connected mechanically to the cam, in order to displace the cam away from the braking nose by means of deliberate action by the user. Thus, when the descender-belay device is used as a descender device, the user can regulate the braking of his descent down the rope by manoeuvring the lever.

In this case, the above-mentioned unlocking button can advantageously be covered by the lever when the latter is at rest, thus preventing untimely manoeuvring of the unlocking button which can give rise to unlocking of the second flange relative to the first flange.

Preferably, the flanges have dimensions such that, in the braking position in which the cam clamps the rope against the braking nose, the cam is entirely accommodated in the transverse gap for passage of the rope. This prevents untimely manipulation of the cam away from the braking nose, and makes the user orient the descender-belay device in order to give rise to the release.

### BRIEF DESCRIPTION OF THE DRAWINGS

Other objectives, characteristics and advantages of the present invention will become apparent from the following description of particular embodiments, which description is provided in relation with the appended figures, in which:

FIG. 1 is a front view of a descender-belay device according to an embodiment of the present invention;

FIG. 2 is a view of the right side of the descender-belay device in FIG. 1;

FIG. 3 is a rear view of the descender-belay device in FIG. 1;

FIG. 4 is an exploded view of the descender-belay device in FIGS. 1 to 3;

FIG. 5 is a view of the right side in cross-section according to the plane A-A in FIG. 1, when the descender-belay device is oriented in order to release the sliding of the rope;

FIG. 6 is a side view in cross-section according to the plane A-A with orientation of the descender-belay device which makes it possible to block the rope;

FIG. 7 is a view of the right side of the descender-belay device in FIG. 1, with the lever raised and the second lateral guide flange displaced into the spaced position, for putting into place and removal of a rope;

FIGS. 8 to 10 illustrate in a side view respectively the initial step, the intermediate step and the final step of displacement of the second lateral guide flange for the rope during its displacement to the spaced position;

FIG. 11 is a view of the left side of the descender-belay device in FIG. 1; and

FIG. 12 is a cross-section according to the plane B-B in FIG. 11, illustrating the locking of a finger for closure of the coupling means.

### DESCRIPTION OF THE PREFERRED EMBODIMENTS

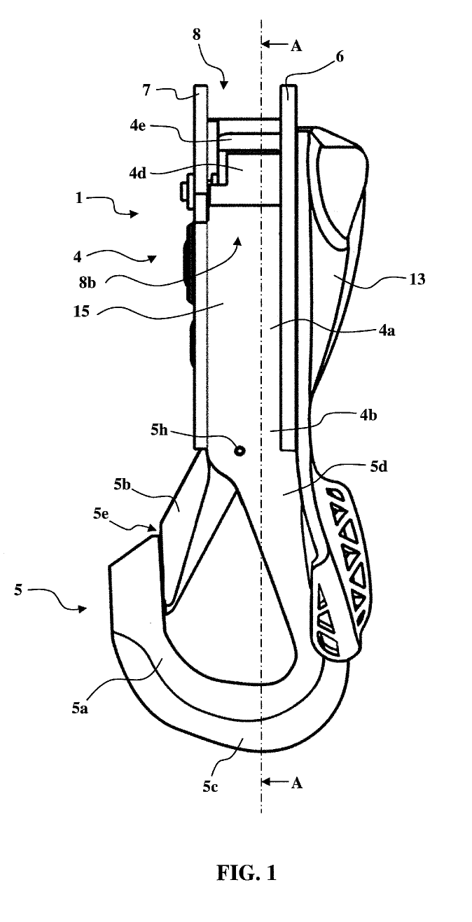

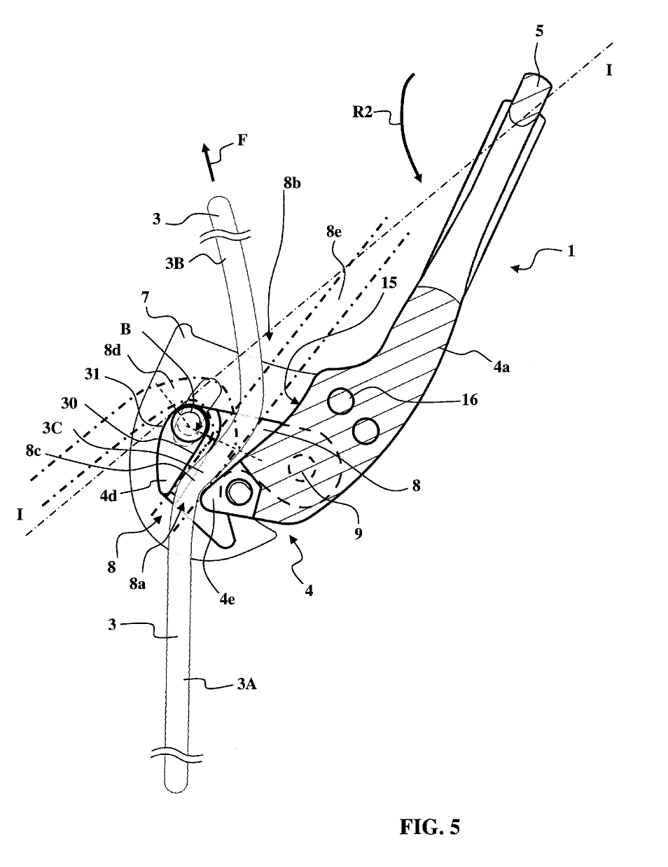

In the embodiment illustrated in FIGS. 1 to 12, the self-blocking descender-belay device 1 according to the invention permits control of the paying-out of a rope 3 (FIGS. 5 to 7) in a paying-out direction which is illustrated by the arrow F. Thus, the rope 3 comprises an input end 3A, an output end 3B, and an intermediate section 3C which passes through the self-blocking descender-belay device 1.

In general, the self-blocking descender-belay device 1 comprises a connection device 4 and coupling means 5.

The connection device 4 is formed so as to ensure a connection with a rope 3, whilst controlling the sliding or blocking of the rope 3 in the connection device 4.

The coupling means 5 are formed so as to permit the selective coupling of the descender-belay device 1 either to a fixed point, or to the harness of a user.

The connection device 4 comprises a connection body 4a with a proximal end 4b which is connected to the coupling means 5.

The connection device 4 additionally comprises second connection means, comprising a braking nose 4e which co-operates with a cam 4d which is fitted such as to be mobile on the connection body 4a, and is designed to press the rope 3 against the braking nose 4e.

In the preferred embodiment illustrated in the figures, the coupling means 5 comprise a connector body 5a, in the form of an open ring, and a closure finger 5b.

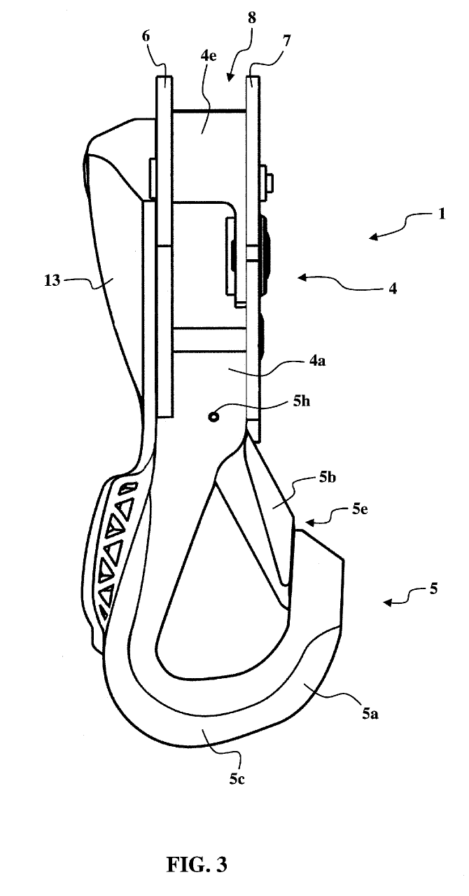

The connector body 5a extends between a proximal end area 5c and a distal end area 5d, and has a lateral opening 5e (FIGS. 1 and 3) which the finger 5b closes in the closed position, and which the finger 5b leaves accessible in the open position.

For this purpose, the closure finger 5b pivots around an articulation shaft 5h which is perpendicular to the general plane of the connector body 5a in the form of an open ring.

In the embodiment illustrated, the proximal end 4b of the connection body 4a forms a continuity with the distal end area 5d of the connector body 5a, such that the connector body 5a and the connection body 4a form a unit assembly with a common rigid body formed by the connection body 4a and the connector body 5a.

As an alternative, coupling means 5 could be designed in the form of a simple aperture provided in the proximal end of the connection body 4a, i.e. without a closure finger, this aperture permitting connection by means of a snap clasp in a manner known per se.

The structure of the connection device 4 is now considered.

A first lateral guide flange 6 for the rope is integral with the connection body 4a, and integral with the braking nose 4e, the first lateral guide flange 6 for the rope preferably being oriented according to a plane perpendicular to the general plane of the connector body 5a.

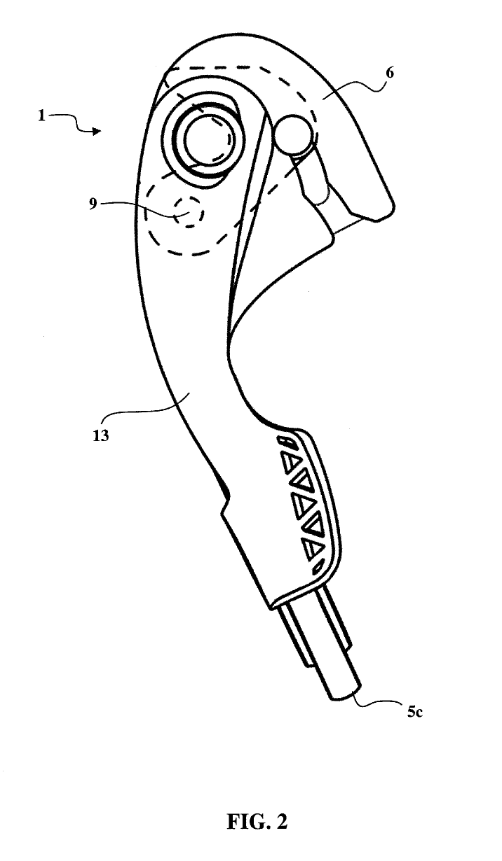

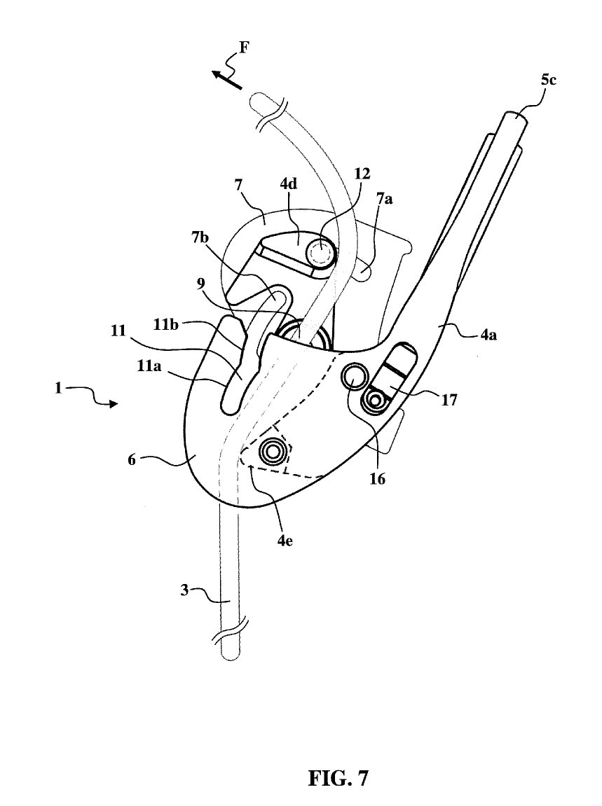

A second lateral guide flange 7 for the rope, parallel to the first lateral guide flange 6 for the rope, is separated from the first lateral guide flange 6 for the rope by means of a transverse path 8 for passage of the rope (FIG. 1). The second lateral guide flange 7 for the rope is fitted such that it can be displaced on the connection body 4a, between a spaced position (FIG. 7) for putting into place and removal of the rope, and a closed position (FIGS. 2, 5 and 6) in which the rope is trapped in the transverse path 8 for passage of the rope.

The braking nose 4e, which is integral with the first lateral guide flange 6 for the rope, passes through the gap between the first and second lateral guide flanges 6 and 7 for the rope.

The cam 4d is engaged between the first and second lateral guide flanges 6 and 7 for the rope, and is fitted such as to be mobile towards and away from the braking nose 4e.

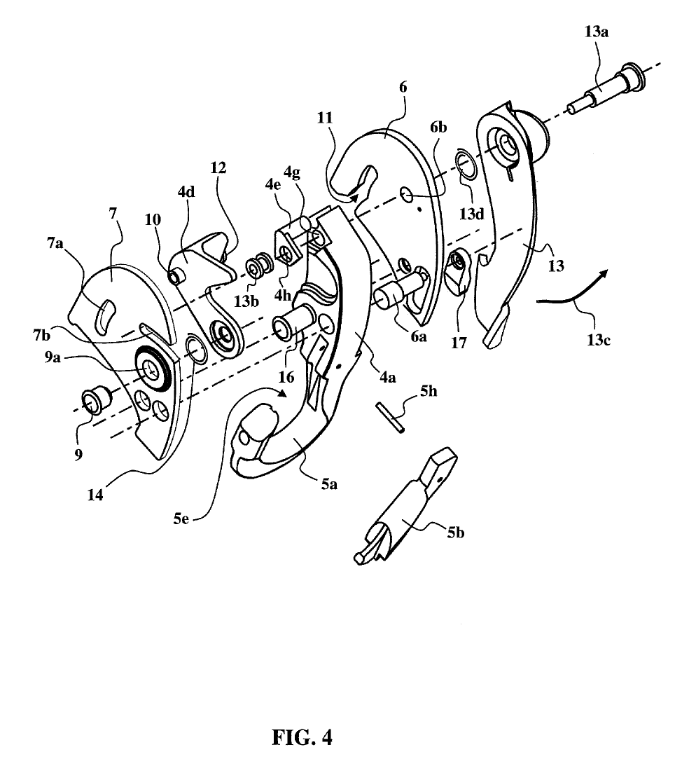

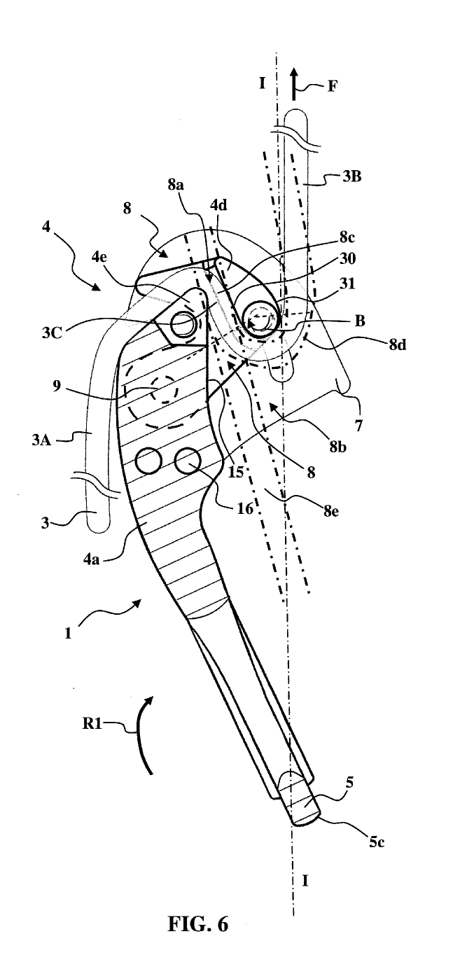

In practice, in the embodiment illustrated, the cam 4d is supported by the second lateral guide flange 7 for the rope, on which it is mobile in rotation around a rotational cam shaft 9. As illustrated in FIG. 4, the rotational cam shaft 9 can be inserted in an aperture 9a in the second lateral guide flange 7 for the rope. The rotational cam shaft 9 (FIG. 6) and the cam 4d are situated respectively on both sides of the transverse path 8 for passage of the rope, and the rotational cam shaft 9 is closer to the proximal end area 5c than the cam 4d is.

In order to reduce the forces withstood by the rotational cam shaft 9, the cam 4d is associated with a first cam lug 10, which, during the rotation of the cam 4d, is displaced in an aperture in the form of an arc of a circle 7a of the second lateral guide flange 7 for the rope (FIG. 4).

The braking nose 4e advantageously consists of a steel wear part added onto the connection body 4a, which itself is made of aluminium alloy, as can be seen in FIG. 4.

The first lateral guide flange 6 for the rope is added and secured on the connection body 4a by rivets such as the rivets 16 and 13a (FIG. 4), and it comprises a slot which constitutes a guide path 11 for a second cam lug 12. This guide path 11 and the second cam lug 12 participate in taking over the forces withstood by the cam 4d. In addition, the guide path 11 makes it possible to fulfill a second function, i.e. the locking of the second lateral guide flange 7 for the rope in the closed position, as will be explained hereinafter.

A lever 13 is articulated on the connection body 4a and the first lateral guide flange 6 for the rope, around the rivet 13a, thus forming a rotational shaft perpendicular to the plane of the first lateral guide flange 6 for the rope, and is arranged on the outer surface of the first lateral guide flange 6 for the rope. In practice, the rivet 13a which forms the rotational shaft of the lever 13 passes through a hole 6b in the first lateral guide flange 6 for the rope, and passes through a hole 4g in the connection body 4a and through a hole 4h in the braking nose 4e, in order to co-operate with a brace 13b, which ensures simultaneously the retention of the rotational shaft 13a, the securing of the braking nose 4e on the connection body 4a, and the guiding of the second flange 7 in sliding in a slot 7b in the second lateral guide flange 7 for the rope.

The lever 13 co-operates with the end of the second cam lug 12, which extends from the guide path 11, thus allowing a user to pivot the cam 4d away from the braking nose 4e, by pivoting the lever 13 in the direction illustrated by the arrow 13c.

Thus, the lever 13 constitutes a cam manoeuvring unit which can be activated by a user in order to displace the cam 4d away from the braking nose 4e.

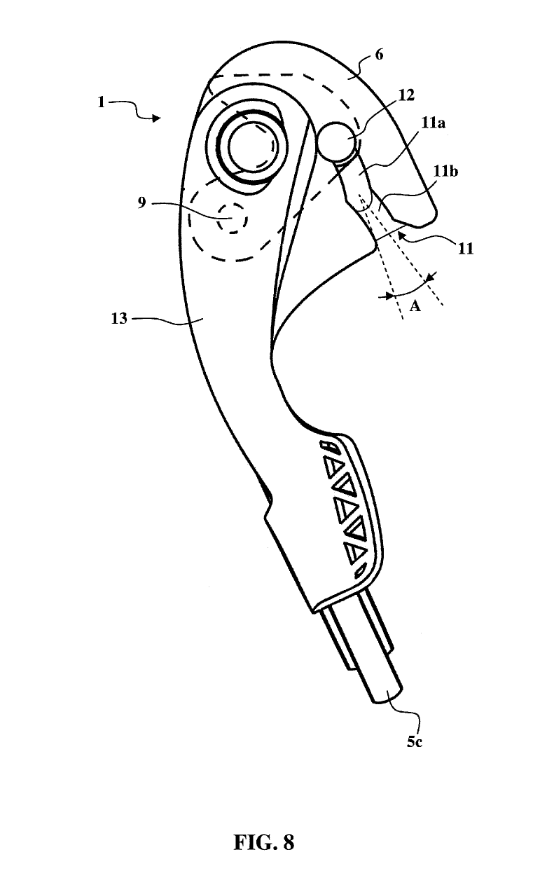

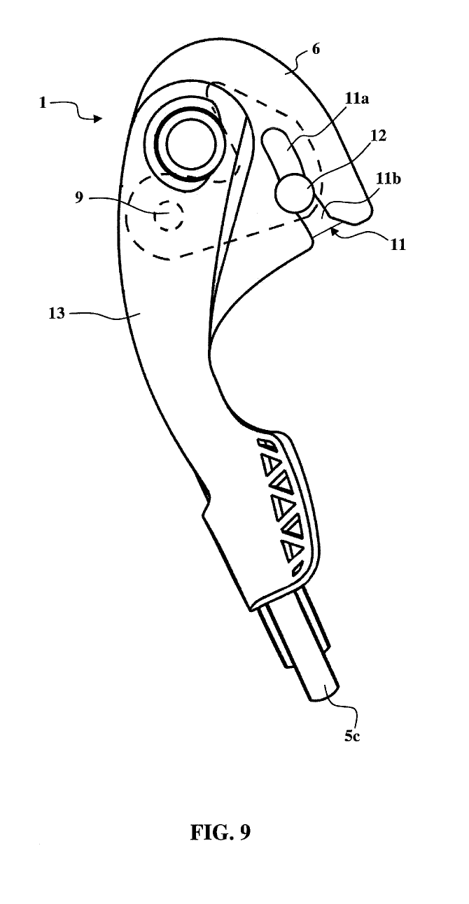

A lever return spring 13d returns the lever to the position of rest which is illustrated in particular in FIGS. 8 and 9, in which the lever is oriented along the connection body 4a, away from the second cam lug 12.

A cam return spring 14 permanently thrusts the cam 4d in its movement between the first and second lateral guide flanges 6 and 7 for the rope, in the direction which brings the cam 4d towards the braking nose 4e.

FIGS. 1, 3, 5 and 6 are now considered more particularly, in order to describe the passage of the rope 3 on the transverse path 8 for passage of the rope.

As can be seen in these figures, the transverse path 8 for passage of the rope is delimited by the first lateral guide flange 6 for the rope, by the second lateral guide flange 7 for the rope, by the braking nose 4e, by the cam 4d, and by the connection body 4a.

The transverse path 8 for passage of the rope extends between a path input 8a in the vicinity of the braking nose 4e, and a path output 8b opposite. Between the path input 8a and the path output 8b, an intermediate section 3C of the rope 3 passes along an intermediate section of path 8c between the braking nose 4e and the cam 4d.

At the path input 8a, the input end 3A of the rope 3 can pass freely around the braking nose 4e, in order to adopt any orientation between a quasi-direct orientation as an extension of the section 3C trapped between the braking nose 4e and the cam 4d (see FIG. 5), and an orientation illustrated in FIG. 6, in which the input end 3A of the rope 3 passes around the braking nose 4e.

According to the present invention, the path output 8b is formed such as to modify the braking of the rope 3 according to the orientation of the output end 3B of the rope 3, between a blocking orientation, illustrated in FIG. 6, in which the output end 3B envelopes the cam 4d, and a release orientation, illustrated in FIG. 5, in which the output end 3B substantially extends the intermediate section 3C of rope between the cam 4d and the braking nose 4e. For this purpose, the path output 8b extends laterally according to a large opening, and widens opposite the intermediate section of path 8c, between the first and second lateral guide flanges 6 and 7 for the rope, from a blocking output portion 8d to a release output portion 8e.

As illustrated in FIG. 6, the cam 4d comprises a clamping section 30, which faces the braking nose 4e, and is followed by a convex guide section 31 which extends in the form of an arc, according to an angle B of more than 90°. The blocking output portion 8d envelops the cam 4d according to its convex guide section 31.

As also illustrated in FIG. 6, opposite the cam 4d, the path output 8b is limited by the connection body 4a, according to a guide surface 15 which defines the release output portion 8e. The release output portion 8e is substantially in line with the path input 8a, and with the intermediate section of path 8c, thus defining a substantially straight passage along which the output end 3B of the rope 3 can pass directly when it is itself in the release orientation illustrated in FIG. 5. In this case, the output end 3B of the rope 3 can slide from the path input 8a to the path output 8b by passing along the intermediate section 8c, without thrusting the cam 4d towards the braking nose 4e. On the contrary, the sliding of the rope 3 tends rather to thrust the cam 4d away from the braking nose 4e, as a result of the particular position of the rotational cam shaft 9.

Thus, as a result of the particular arrangement of the cam 4d and its rotational shaft 9 and as a result of the particular arrangement of the path output 8b, the cam 4d is arranged such that, when the output end 3B of the rope is in the blocking orientation and passes along the blocking output portion 8d whilst enveloping the cam 4d, tension of the output end 3B of the rope then thrusts the cam 4d towards the braking nose 4e, in such a way that, when the output end 3B of the rope is in the release orientation and passes along the release output portion 8e without enveloping the cam 4d, tension of the output end 3B of the rope does not thrust the cam 4d towards the braking nose 4e, but on the contrary longitudinal sliding of the rope 3 thrusts the cam 4d away from the braking nose 4e.

During use of the self-blocking descender-belay device 1, the user orients the self-blocking descender-belay device 1 with respect to the rope, as illustrated in FIGS. 5 and 6. In FIG. 6, the orientation of the self-blocking descender-belay device 1 is left free by the user around coupling means 5, and the device begins itself to rotate R1 towards a braking position, in which the connection device 4 is directed towards the output end 3B, thus exerting braking on the rope 3. In this case, when traction F is exerted according to the traction axis I-I, between the output end 3B and the proximal end area 5c of the coupling means 5, the self-blocking descender-belay device 1 prevents sliding on the rope 3. For this purpose, as can be seen in FIG. 6, the output end 3B of the rope 3 passes around the cam 4d, and gives rise to rotation of the cam 4d around its rotational shaft 9, in the direction which brings it towards the braking nose 4e, such that the intermediate section 3C of the rope 3 is gripped between the cam 4d and the braking nose 4e, thus preventing sliding of the rope 3.

In FIG. 5, the self-blocking descender-belay device 1 is deliberately brought into the release position, in which the connection device 4 is pushed back opposite the output end 3B by thrusting R2 by the user, thus making it possible to release the sliding of the rope 3. In this case, the input end 3A, the intermediate section 3C and the output end 3B are substantially aligned with one another, in other words the rope 3 passes along the transverse path 8 for passage of the rope directly. This is made possible by the fact that the guide surface 15 is substantially parallel to the traction axis I-I, thus allowing the output end 3B to be brought closer to the coupling means 5. In this case, when it slides towards the path output 8b, the rope 3 slides between the braking nose 4e and the cam 4d, without thrusting the cam 4d around its rotational shaft 9 towards the braking nose 4e. Only the action of the cam return spring 14 (FIG. 4) thrusts the cam 4d back towards the braking nose 4e by gripping the rope 3 slightly, but this slight gripping does not prevent the sliding of the rope 3 towards the path output 8b.

Preferably, the user assists the sliding of the rope 3 further by pulling the output end 3B manually parallel to the traction axis I-I, in which orientation the braking is minimal.

By using the blocking position in FIG. 6 and the sliding position in FIG. 5, the user can, for example, secure a climber whose progress requires the rope 3 to slide, and who must be retained safely if he falls, i.e. during traction of the rope according to the arrow F as indicated in FIG. 6. For the blocking, the user simply releases the self-blocking descender-belay device 1, which, from the release position in FIG. 5, pivots automatically to the blocking position in FIG. 6 under the effect of the traction of the rope 3 according to the arrow F, with the traction axis I-I then being oriented in line with the output end 3B of the rope 3.

In order to allow the rope 3 to be put into place and removed, the second lateral guide flange 7 for the rope can be displaced between a spaced position, illustrated in FIG. 7, and a closed position illustrated in FIGS. 5 and 6. Between these two positions, the second lateral guide flange 7 for the rope pivots on the connection body 4a, around a flange shaft 16.

As can be seen in FIGS. 5 to 7, on the second lateral guide flange 7 for the rope, the flange shaft 16 is offset relative to the cam shaft 9, in the direction of the coupling means 5.

In the closed position illustrated in FIGS. 5 and 6, the two lateral guide flanges 6 and 7 for the rope are opposite one another, and trap the rope 3 in the transverse gap 8 for passage of the rope, between the connection body 4a, the braking nose 4e and the cam 4d. On the other hand, in the spaced position, the second lateral guide flange 7 for the rope is pivoted sufficiently around the flange shaft 16 for the cam 4d to be spaced from the first lateral guide flange 6 for the rope, and allows the rope 3 to be put into place and removed as illustrated in FIG. 7.

As can be seen in FIG. 6, in the braking position in which the cam 4d clamps the rope 3 against the braking nose 4e, the cam 4d is entirely accommodated in the transverse gap 8 for passage of the rope, the contour of the cam 4d being recessed from the contour of the lateral guide flanges 6 and 7 for the rope.

For safety reasons, it is important to prevent selectively the free rotation of the second lateral guide flange 7 for the rope towards its spaced position, in order to avoid untimely output of the rope 3 from the self-blocking descender-belay device 1. For this purpose, a first locking means consists of providing the guide path 11 of the second cam lug 12 with a particular form, as illustrated in FIGS. 2, 4, 8, 9, and 10.

In this case, the guide path 11 comprises two successive sections, i.e.:
a first guide section 11a in the form of an arc of a circle centered on the rotational cam shaft 9, such that the second cam lug 12 can follow this first section 11a during the movement of rotation of the cam 4d, in its habitual movements of being brought closer to the braking nose 4e and moved away from it, for the clamping or release of the rope 3;
a second guide section 11b in the form of an arc of a circle centered on the flange shaft 16, which permits the orientation of the second cam lug 12 during the pivoting of the second lateral guide flange 7 for the rope to its spaced position;
the two guide sections 11a and 11b being connected according to an angle A which is not zero.

In this case, for as long as the cam 4d is at the bottom of the guide path 11, to which it is thrust back by the cam return spring 14, the second cam lug 12 prevents any pivoting of the second lateral guide flange for the rope around the rivet 16, which itself is structured in order to constitute the flange shaft 7, since the first guide section 11a is not centered on this flange shaft 16. The opening of the self-blocking descender-belay device 1 by pivoting of the second lateral guide flange 7 for the rope is possible only by means of a double manoeuvre, i.e. a first pivoting of the cam 4d around its rotational cam shaft 9, in order to bring the second cam lug 12 to the start of the second guide section 11b, then a movement of rotation of the second lateral guide flange 7 for the rope around its flange shaft 16. FIGS. 8 and 9 illustrate respectively the start and end of this first movement. FIGS. 9 and illustrate respectively the start and end of the second movement.

An additional safety device can be provided in order to prevent untimely opening of the self-blocking descender-belay device 1. This then consists of providing a lock which can be activated by an unlocking button 17, the lock being arranged between the second lateral guide flange 7 for the rope and the connection body 4a. In this case, a third manoeuvre is necessary in order to ensure the unlocking, by action on the unlocking button 17, by pivoting of the cam 4d, then by pivoting of the second lateral guide flange 7 for the rope.

The structure and function of the lever 13 are now considered in relation to FIGS. 1, 4, 8 and 10.

This lever 13 is used when the self-blocking descender-belay device 1 is oriented as illustrated in these figures, with the coupling means 5 facing downwards, and with the braking nose 4e facing upwards. The self-blocking descender-belay device 1 is then used as a descender device, in order to brake the progression of the user's descent down the rope 3, or as a belay device in order to brake the paying-out of the rope which is retaining a climber during his descent.

The lever 13 is returned to the position of rest illustrated in FIGS. 1 and 8 by the lever return spring 13d (FIG. 4). In this position, the lever 13 is spaced from the second cam lug 12, thus allowing the cam 4d to be displaced under the action of the cam return spring 14 and the rope 3.

The self-blocking descender-belay device 1 is then initially in the blocking position illustrated in FIG. 6, with the user being coupled to the coupling means 5, the output end of the rope 3B being coupled to a fixed high point. Since the self-blocking descender-belay device 1 is oriented as shown in the figure, the cam 4d is thrust back towards the braking nose 4e, and prevents the sliding of the rope 3.

Since the user is suspended by the coupling means 5, it would not be possible for him to incline the self-blocking descender-belay device 1 towards the position of release as illustrated in FIG. 5, in order to permit the sliding of the rope 3.

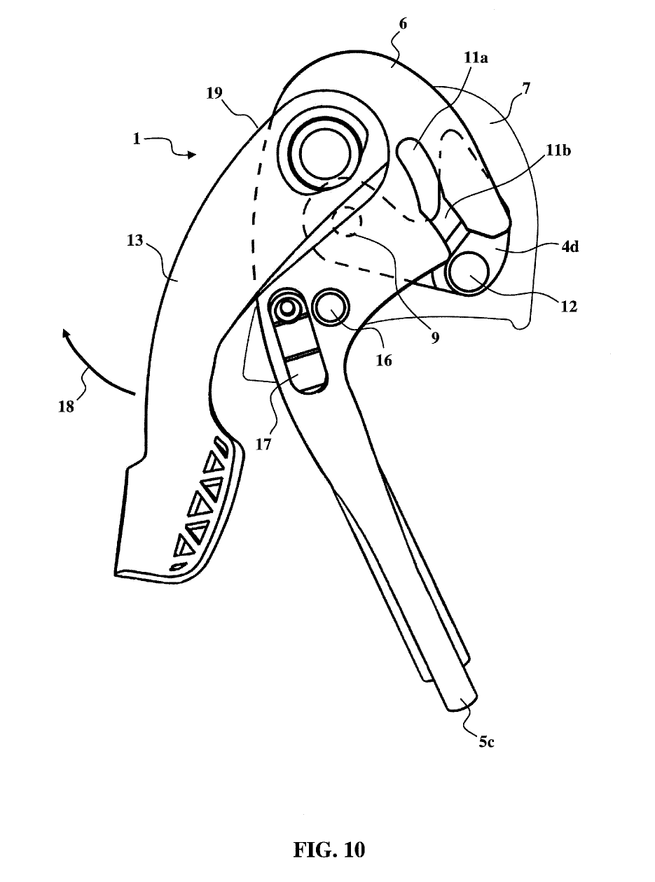

In the descender function, it is then necessary to manoeuver the lever 13 in order to modify the braking on the rope 3. For this purpose, by means of the rotation of the lever 13 in the direction of the arrow 18 illustrated in FIG. 10, after rotation of more than half a turn, the outer ridge 19 of the lever 13 abuts the second cam lug 12, and thus makes it possible to thrust the cam 4d back spaced from the braking nose 4e by rotation around the rotational cam shaft 9. The user can thus regulate the braking on the rope 3.

As can be seen in the figures, in the position of rest the lever 13 covers the unlocking button 17, thus forming an additional safety device to prevent the unlocking of the second lateral guide flange 7 for the rope.

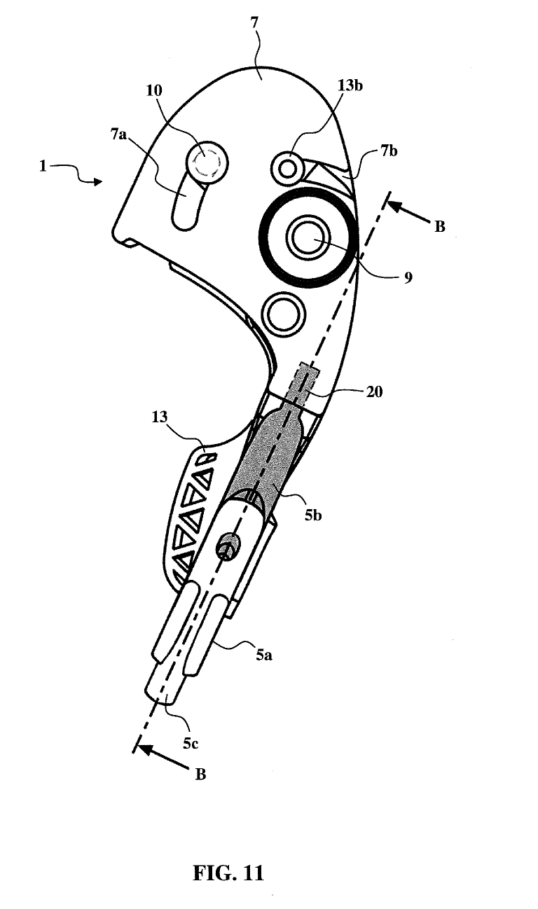

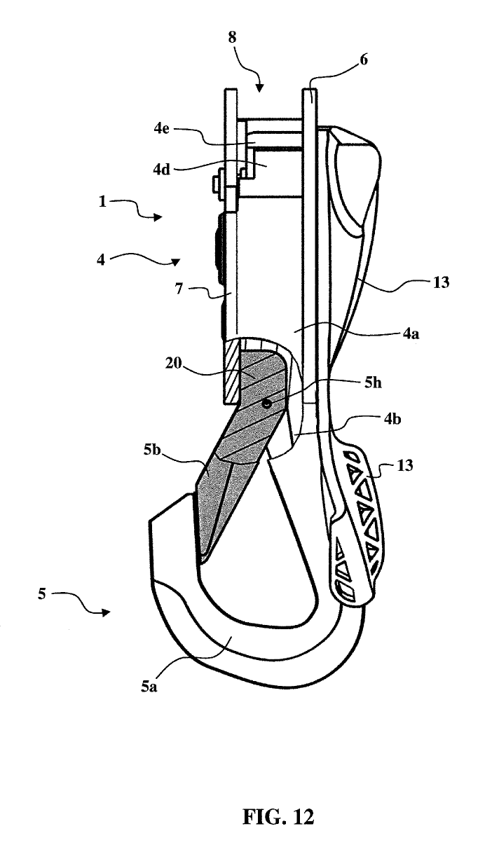

FIGS. 11 and 12 are now considered, which illustrate a detail of an embodiment of the coupling means 5 and their locking means.

In this case the closure finger 5b which is articulated on the connector body 5a according to the articulation shaft 5h comprises a locking segment 20 which extends the closure finger 5b beyond the articulation shaft 5h. In the closed position as illustrated in the figures, the second lateral guide flange 7 for the rope covers this locking segment 20, thus preventing the pivoting of the closure finger 5b towards the inner space of the connector body 5a, i.e. thus preventing the opening of the coupling means 5. By this means, the second lateral guide flange 7 for the rope itself constitutes a means for locking the coupling means 5, such that the user cannot uncouple himself until the rope has been withdrawn after pivoting of the second lateral guide flange 7 for the rope to its spaced position.

The present invention is not limited to the embodiments which have been explicitly described, but includes the various variants and generalisations contained within the scope of the following claims.

1. A self-blocking descender-belay device to control the paying-out of a rope, comprising:
a first lateral guide flange for the rope, which is integral with a braking nose,
a second lateral guide flange for the rope, which is separated from the first lateral guide flange for the rope by a path for passage of the rope, and can be displaced between a spaced position for putting into place and removal of the rope, and a closed position in which the rope is trapped in the transverse gap for passage of the rope,
a cam which is engaged between the first and second lateral guide flanges for the rope, and is mobile towards and away from the braking nose, from which it is separated by an intermediate section of path,
a cam manoeuvring unit, which can be activated by a user, in order to displace the cam away from the braking nose,
a cam return spring, in order to thrust the cam towards the braking nose, in its movement between the first and second flanges,
the path for passage of the rope extending on both sides of the intermediate section of path, between a path input in the vicinity of the braking nose, and a path output,
the path output comprising a blocking output portion which passes round the cam, and along which there can pass an output end of the rope, which thus thrusts the cam towards the braking nose,
at least one of the first and second flanges extending longitudinally from a connection end, where there are situated the braking nose, the cam and the path for passage of the rope, to a proximal end area where coupling means are situated,
wherein:
the path output extends laterally according to a large opening, between the first and second flanges, from the blocking output portion, to a release output portion which is in line with the path input and the intermediate section of path, in order to define a generally straight passage, along which the output end of the rope can pass directly, without thrusting the cam towards the braking nose.

2. The self-blocking descender-belay device according to claim 1, wherein, in its movement towards and away from the braking nose, the cam is guided by guide slides.

3. The self-blocking descender-belay device according to claim 1, wherein the cam is mobile in rotation around a rotational cam shaft, which, in relation to the cam, is situated on the other side of the intermediate section of path, and is offset in the direction of the proximal end area.

4. The self-blocking descender-belay device according to claim 3, wherein the cam is supported by the second lateral guide flange for the rope.

5. The self-blocking descender-belay device according to claim 4, wherein the cam is associated with a first cam lug, which is displaced in an aperture in the form of an arc of a circle provided in the second lateral guide flange for the rope.

6. The self-blocking descender-belay device according to claim 3, wherein the cam is associated with a second cam lug which is displaced on a guide path provided in the first lateral guide flange, and in that the guide path comprises two successive guide sections, i.e.:
a first section for guiding according to the movement of rotation of the cam on the second flange around the rotational cam shaft,
a second section for guiding according to a movement of rotation of the second flange relative to the first flange around a flange shaft,
the rotational cam shaft and the flange shaft being spaced apart from one another, and the second guide section being connected to the first guide section by an angle which is not zero.

7. The self-blocking descender-belay device according to claim 6, wherein it additionally comprises a button for unlocking of the second lateral guide flange relative to the first lateral guide flange.

8. The self-blocking descender-belay device according to claim 1, wherein the cam manoeuvring unit comprises a lever which is articulated on one of the lateral guide flanges, and is connected mechanically to the cam, in order to displace the cam away from the braking nose by means of deliberate action by the user.

9. The self-blocking descender-belay device according to claim 7, wherein the unlocking button is covered by the lever when the latter is at rest.

10. The self -blocking descender-belay device according to claim 1, wherein, in the braking position in which the cam clamps a rope against the braking nose, the cam is entirely accommodated in the transverse gap for passage of the rope.
